(19) United States
(12) Patent Application Publication
(10) Pub. No.: US 2007/0182292 A1
(43) Pub. Date: Aug. 9, 2007

(54) Interlock mechanism for drawer slide rail

(75) Inventor: Kuo-Sheng Huang, Taipei Hsien (TW)

Correspondence Address: BRUCE H. TROXELL, SUITE 1404, 5205 LEESBURG PIKE, FALLS CHURCH, VA, 22041, US

(73) Assignee: NAN JUEN INTERNATIONAL CO., LTD.

(21) Appl. No.: 11/411,787

(22) Filed: Apr. 27, 2006

(30) Foreign Application Priority Data
Feb. 8, 2006 (TW) 095202218

(51) Int. Cl. E05C 7/06

(52) U.S. Cl. 312/221

(57) ABSTRACT

The present invention discloses an interlock mechanism for drawer slide rail, which is installed in at least two vertically arranged drawers, each of which outer wall and an object's inner wall are provided with a drawer slide rail, respectively, formed by an inner and outer slide rails. The interlock mechanism comprises a seat housing, an actuator, a rotating part, at least a follower, and a hook bolt. When the actuator moves into position along the inner slide rail, a spline will drive a turning tenon of the rotating part to protrude over the limit groove of the seat housing, and thus the motion of the turning tenon changes from linear movement to rotating movement so as to turn the rotating part into rotating movement, and in turn drive the push rod's long side to push the joint of the follower to move longitudinally. Furthermore, the present invention further comprises an automatic retracting mechanism, in which the hook bolt on the end of the inner slide rail can be retracted automatically with respect to the seat housing on the end of the outer slide rail.

### FIELD OF THE INVENTION

The present invention relates an interlock mechanism for drawer slide rail and in particular to an interlock mechanism for drawer slide rail used in at least two vertically arranged drawers and when one drawer is pulled out, other closed drawers can remain at their original positions so as to prevent the drawers coming off. Furthermore, the present invention comprises an automatic retracting mechanism, in which the hook bolt on the end of the inner slide rail can be retracted automatically with respect to the seat housing on the end of the outer slide rail.

### BACKGROUND OF THE INVENTION

Using drawers to store things has been a long history. Since drawers can be selectively opened or closed, they are widely used in furniture, office desk, file cabinet, and so on. For the best use of space, a plurality of drawers are usually piled up vertically for the purpose of storage, which is usually seen in file cabinets or office desks.

In this kind of vertically arranged drawers, the use of drawers usually is exclusive during operation of drawers, i.e. when one drawer is pulled out, other drawers should be prevented from sliding open. As a result, the interlock mechanism has been developed to overcome the problem.

Furthermore, apart from providing the function of pulling out drawers, the drawer slide rail should also be designed to cut down the need for human involvement in pushing back drawers. Consequently, some companies have developed different designs of automatic homing or retracting mechanism, such that when one pushes back a drawer, it will be automatically sliding back to close before one pushing the drawer right down to the end.

US patent No. 2005/0040739 A1, for example, is one of the design of rear interlock mechanism. The present invention provides a rear interlock mechanism, wherein the inclined plane of an actuator installed in the end of the inner slide rail is operated together with the two respective inclined reset planes of two followers installed in the end of the outer slide rail to drive the two followers to outwardly push up and down and in turn to push the followers of upper and lower drawers, such that the gap between them is reduced to prevent respective drawers from sliding open. Namely, when a drawer is being closed, the actuator is driven back to the rear end of the drawer slide rail, and the two followers are moved into a partitioned non-blocking position along the longitudinal direction of the drawer slide rail, such that the two followers are driven to a plate blocking position.

The invention described above can achieve the expected function of automatic retraction, wherein a loop groove is cut in the end of the actuator installed in the end of the inner slide rail and a housing installed in the end of the outer slide rail is connectingly provided with a transversally movable plate whose front edge is provided with a arc groove from which a movable bolt tenon can protrude. When the drawer is being pulled out, the actuator moves outwardly and the loop groove will drive the bolt tenon and the plate to move forward until the bolt tenon reaches the plate blocking location; when the drawer is being closed, the actuator returns to the rear end of the outer slide rail and connects with the loop groove and, then the bolt tenon and changes their positions to disengage from the latching condition. At this moment, with the retraction of the spring between the plate and the housing, the bolt tenon drives the actuator back to its original position so as to achieve the automatic retracting function. The drawback of the invention described is that since the precision of the bolt tenon and the loop groove is very high, if dimensional error occurs during the installation of drawer slide rails, the bolt tenon cannot be accurately connected with the loop groove, such that the automatic retracting function cannot be achieved.

### SUMMARY OF THE INVENTION

Accordingly, the present applicant has involved in the designing and marketing of slide rail for years to overcome the drawback of the interlock mechanism described above. After repeated experiments and trials, the applicant has successfully developed the present invention, interlock mechanism for drawer slide rail.

An object of the present invention is to provide an interlock mechanism for drawer slide rail, which is installed in at least two vertically arranged drawers, each of which outer wall and an object's inner wall are provided with a drawer slide rail, respectively, formed by an inner and outer slide rails. The interlock comprises: a seat housing connectingly provided in the end of an outer slide rail, wherein the center of the seat housing extends outwardly to form a belt-like protrusion which is provided with a arc limit groove in its middle; an actuator comprising a cover plate slidingly connected in front of the seat housing and a twisted spline provided on the inner side of the cover plate corresponding to the limit groove; a rotating part axially connected to the back of the seat housing, wherein the inner side of the rotating part axially extends to form a push rod whose one end is protrudingly provided with a turn tenon which passes through the limit groove and is fittingly connected with the spline; at least a follower slidingly provided on the back of the seat housing and adjacently connected to the recessed joint provided on the rotating part; and a hook bolt connectingly provided at the end of a slide rail. When the actuator moves into position along the inner slide rail, a spline will drive a turning tenon of the rotating part to protrude over the limit groove of the seat housing, and thus the motion of the turning tenon changes from linear movement to rotating movement so as to turn the rotating part into rotating movement, and in turn drive the push rod's long side to push the joint of the follower to move longitudinally.

Another object of the present invention is to provide an interlock mechanism for drawer slide rail, further comprising an automatic retracting mechanism which comprises: a seat housing connectingly provided in the end of an outer slide rail, wherein the center of the seat housing extends outwardly to form a protrusion whose front portion is cut to form a guide groove formed by a linear portion and a curved portion interlinked with the front of the linear portion; an actuator comprising a cover plate slidingly connected in front of the seat housing and a spring connectingly provided between the actuator and the cover plate whose front end is formed a groove and an axial hole; a swinging part whose top is protrudingly provided with an axial rod for the pivotal connection of the axial hole, whose bottom protrudes to form a belt-like guide rod fittingly connected to the guide groove, and whose respective sides on its top are provided with a hook end and a hook stop, respectively, between which a hook groove is formed; and a hook bolt connectingly provided at the end of the inner slide rail and protrudingly provided with two detached locking teeth corresponding to the groove. With the inner slide rail being pulled out, the spring extends and in turn the guide rod touches the outer edge of the curved portion to turn the swinging part, which is in close contact with and located at the inclined wall of the curved portion. The swinging part therefore moves to an inclined position to render the hook bolt to disengage from the latching of the swinging part. With the inner slide rail being pushed back, the locking teeth of the hook bolt contact hook groove's inner wall of the swinging part provided at the curved portion and are accommodated inside the hook groove so as to disengage from latching and in turn to retract the spring to drive the actuator and the hook bolt retract along linear portion automatically.

Still another object of the present invention is to provide an interlock mechanism for drawer slide rail, wherein behind the seat housing is provided with a curved portion for the fitting connection of a spring, on the back of the actuator is protrudingly provided with two spring tenons which are connected with both sides of the spring, respectively. Furthermore, the upper and lower sides of the seat housing are provided with a pair of parallel wing grooves and the upper and lower sides of the actuator's cover plate extend to form a wing plates, respectively, whose edges are provided with hook grooves bending downwards to fasten with the wing grooves, such that the actuator can move transversely on the surface of the seat housing. Also, the upper and lower of the front end of the cover plate bend, respectively, downwards to form fastening wings so as to fasten with the upper and lower edges of the protruding portion.

Still another object of the present invention is to provide an interlock mechanism for drawer slide rail, wherein a relay rail is provided between the outer slide rail and the inner slide rail.

Still another object of the present invention is to provide an interlock mechanism for drawer slide rail, wherein the inner of the notch on the back of the seat housing is adjacently connected with the an axial tenon protrudingly formed from one side of the limit groove such that the tenon hole on the center of the rotating part can be pivoted rotatably therein. Moreover, the left and right sides of the notch opposingly form a pair of plate grooves, such that the two plate edges of the two ends of the actuator can move longitudinally on the plate groove. Also, the intersections of the notch and the wing grooves form a stop rod, respectively, to act the limits of the movement of the stop plate protrudingly formed from the front of the actuator.

### BRIEF DESCRIPTION OF THE DRAWINGS

The present invention can be more fully understood by reference to the following description and accompanying drawings, in which:

FIGS. 1a and 1b are exploded perspective views of different view angles of an interlock mechanism according to the present invention;

FIGS. 2a and 2b are perspective assembly views of different view angles of an interlock mechanism according to the present invention;

FIG. 3 an exploded perspective view of a slide rail installed in a drawer;

FIGS. 4a and 4b are schematic illustrations of the operation of an interlock mechanism according to the present invention;

FIGS. 5a through 5c are schematic illustrations of the operational procedure of the normal condition of an automatic retraction mechanism according to the present invention; and

FIGS. 6a through 6g are schematic illustrations of the operational procedure of the abnormal condition of an automatic retraction mechanism according to the present invention.

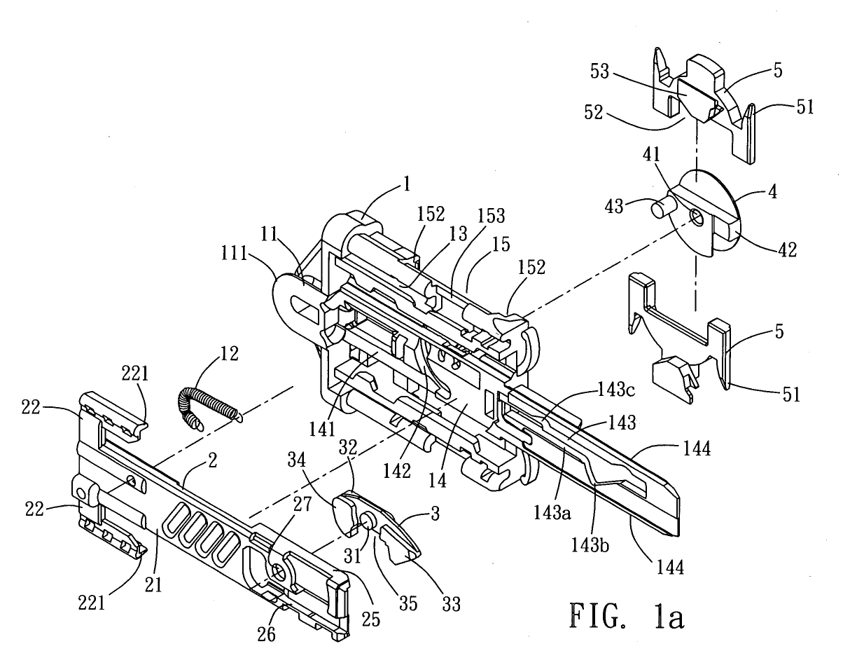

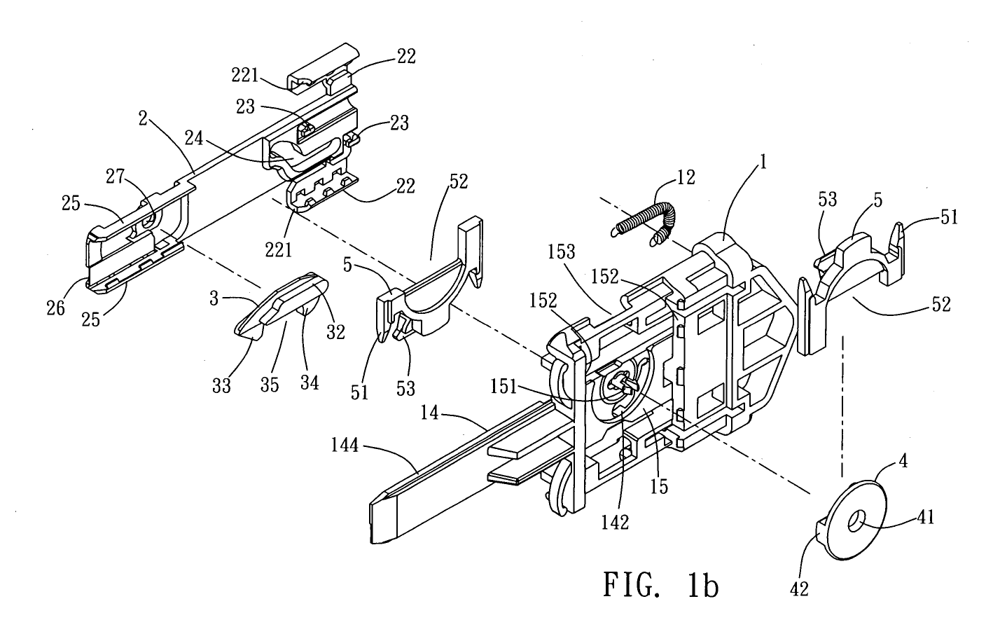

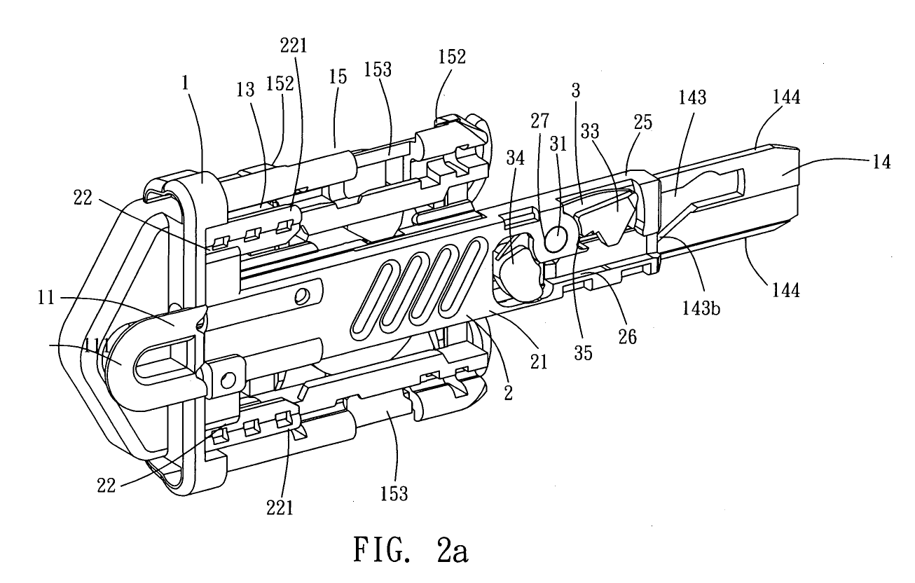

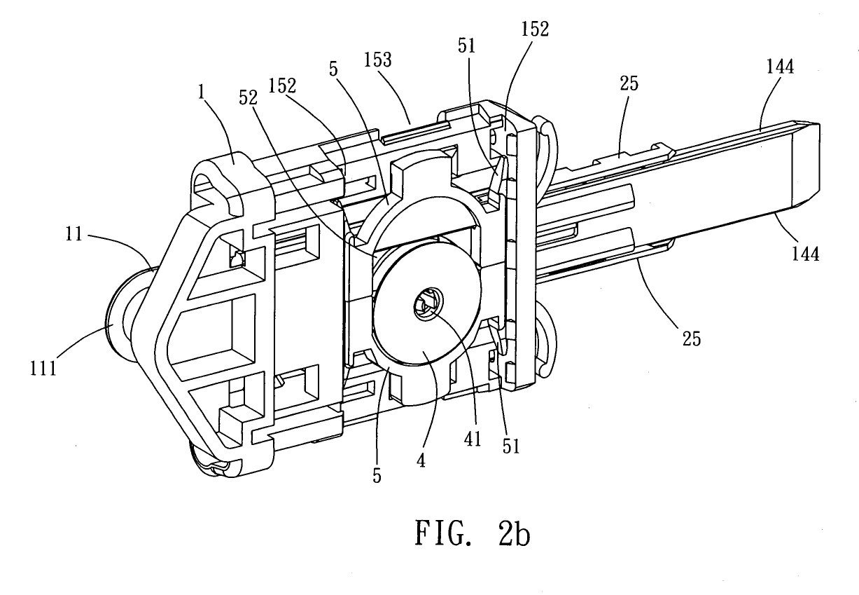

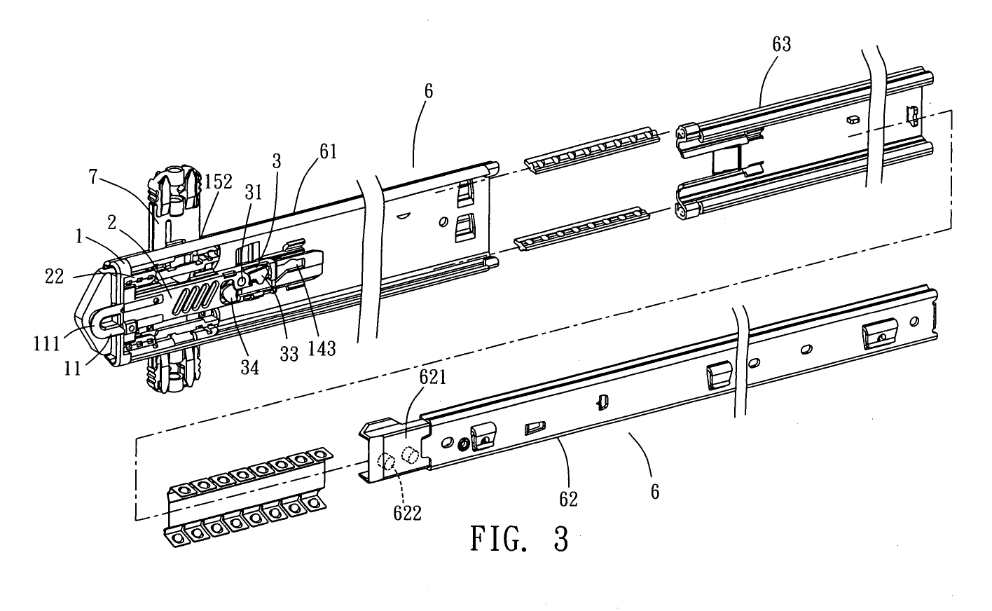

### DETAILED DESCRIPTION OF THE INVENTION

Referring to FIGS. I to 3, an interlock mechanism for drawer slide rail according to the present invention comprises a seat housing 1, an actuator 2, a swinging part 3, a rotating part 4, at least a follower 5, and drawer slide rails 6, wherein the interlock mechanism is used in a furniture main body, a cupboard for example, provided with a set of drawer, two or more vertically arranged drawers for example, for the pulling out from or pushing back into of the drawers, such that the interlock mechanism can push the followers of the upper and lower drawers to reduce their spacing and thus prevent the drawers from coming off.

The seat housing 1 is connectingly provided in the end of the outer slide rail 61 of the drawer slide rail 6, and the outer slide rail 61 is provided in a furniture main body, the inner wall of a cupboard for example. The rear of the seat housing 1 is protrudingly provided with a curved portion 11 having a stop edge 111 to provide the fitting connection of a spring 12. The upper and lower sides of the set housing 1 are provided with a pair of parallel wing grooves 13 such that the actuator 2 can move horizontally on the seat housing 1. Furthermore, to enable the rotation of the rotating part 4, an arc limit groove 142 is provided between the two spring grooves 141 on the upper and lower sides of the central belt-like protrusion 14 situated between the two wing grooves 13, to accommodate the turn tenon 43 protrudingly provided on the rotating part 4 and to limit the rotation angle of the rotating part 4. The inner side of the notch 15 on the back of the protrusion 14 of the seat housing 1 is adjacently connected to an axial tenon 151 protrudingly provided on one side of the limit groove 142 such that the rotating part 4 can be pivotally connected and be rotatable.

Furthermore, the left and right sides of the notch 15 opposingly form a pair of plate groove 152 so as to enable the two followers 5 to move longitudinally in the plate groove 152. The intersections of the wing grooves 13 and the notch 15 form a stop rod 153, respectively, to act as the upper and lower limits of the movement of the two followers 5. Furthermore, the protrusion 14 extends forwards so as to guide the actuator 2 to glide thereon. Referring to the figures, the front surface of the protrusion 14 is cut to form a guide groove 143 comprising a linear portion 143a and a curved portion 143b linked with the front of the linear portion 143a.

The upper and lower. sides of the cover plate 21 of the actuator 2 extend to form a wing plate 22, respectively, whose edges are provided with hook grooves 221 bending downwards to fasten with the corresponding wing grooves 13, such that the actuator 2 can move transversely on the surface of the seat housing 1. On the back of the actuator 2 is protrudingly provided with two spring tenons 23, which are connected with both sides of the spring 12 described above, respectively. Also, the inner side of the cover plate 21 corresponding to the turn tenon 43 which passes through the limit groove 142 is cut to form a twisted spline 24, such that the actuator 2 move transversally to drive the turn tenon 43 to rotate in the limit groove 142 and in turn drive the rotating part 4 to rotate accordingly. Furthermore, the upper and lower sides of the front end of the cover plate 21 bend, respectively, downwards to form fastening wings 25 so as to fasten with the upper and lower edges 144 of the protruding portion 14. Moreover, the front end of the actuator 2 is provided with a groove 26, over which is provided with an axial hole 27 to be pivotally connected with the swinging part 3.

The swinging part 3 is a strip part whose top is protrudingly provided with an axial rod 31 to be pivotally connected with the axial hole 27 of the. actuator 2 and whose bottom is protrudingly provided with a belt-like guide rod 32 to be fittingly connected into the guide groove 12, such that the swinging part 3 can transversally move in the guide groove 143. Furthermore, the two ends of the axial rod 31 are provided with a hook end 33 and a hook stop 34, respectively, between which a hook groove 35 is formed.

The rotating par 4 is circular plate whose center is provided with a tenon hole 41 for the passing and pivotal connection of the axial tenon 151, whose inner side axially extends to form a push rod 42, and whose one side is protrudingly provided with a turn tenon 43. The turn tenon 43 passes through the limit groove 142 and fittingly connects into the spline 24. Therefore, when the actuator 2 moves transversally, the spline 24 drives the turn tenon 43 to change from linear movement to rotating movement in the limit groove 42, and in turn both ends of the long side of the push rod 42 is driven to push the followers 5, respectively.

The follower 5 is a Y-shape plate, as shown in the figures. Two followers 5 are opposingly disposed into the notch 15 and move longitudinally in the notch 15 with its two plate edges 51 on left and right sides fittingly connected with the opposingly disposed plate grooves 152. A recessed joint 52 is provided on the two followers 5, respectively, adjacent to the rotating part 4. When the rotating part 4 rotates, the two joints 52 contact with the push rod 42 from its short side to its long side and simultaneously push top-down arranged followers 5 to move longitudinally, and the two followers 5 in turn drive a relay part 7 and its linking bar 71 to push the followers of upper and lower drawers, such that the gap between them is reduced to prevent respective drawers from coming off. Furthermore, to prevent the followers 5 from coming off from the notch 15, the front of the follower 5 is protrudingly provided with a L-shape stop plate 53, such that when the follower 5 moves longitudinally, the stop plate 53 is hooked with the stop rod 153, which is the limit of the movement to prevent the followers 5 from coming off.

The drawer slide rail 6 comprises an outer slide rail 61 and an inner slide rail 62 between which is provided with conventional ball supports and balls, such that the inner slide 62 can move transversally with respect to the outer slide 61. If the length of the movement of the whole set of drawer is to increase, the outer slide rail 61 and the inner slide rail 62 can be provided with a relay rail 63 between them, which is a convectional prior art and will not be discussed further. As described earlier, the seat housing 1 is provided in the end of the outer slide rail 61 to perform the automatic retraction function according to the present invention. Consequently, a hook bolt 621 provided at the end of the inner slide rail 62 is protrudingly provided with two detached locking teeth 622 corresponding to the groove 26. When the locking teeth 622 are placed inside the linear portion 143a of the guide groove 143, the two locking teeth 622 of the hook bolts 621 is engaged and latched in the hook groove 35 of the swinging part 3; when the locking teeth 622 are placed inside the curved portion 143b of the guide groove 143, the two locking teeth 633 of the hook bolts 621 are disengaged from the hook groove 35 of the swinging part 3. The corresponding operations of the guide groove 143, the swinging part 3, and the hook bolt 621 will be described later.

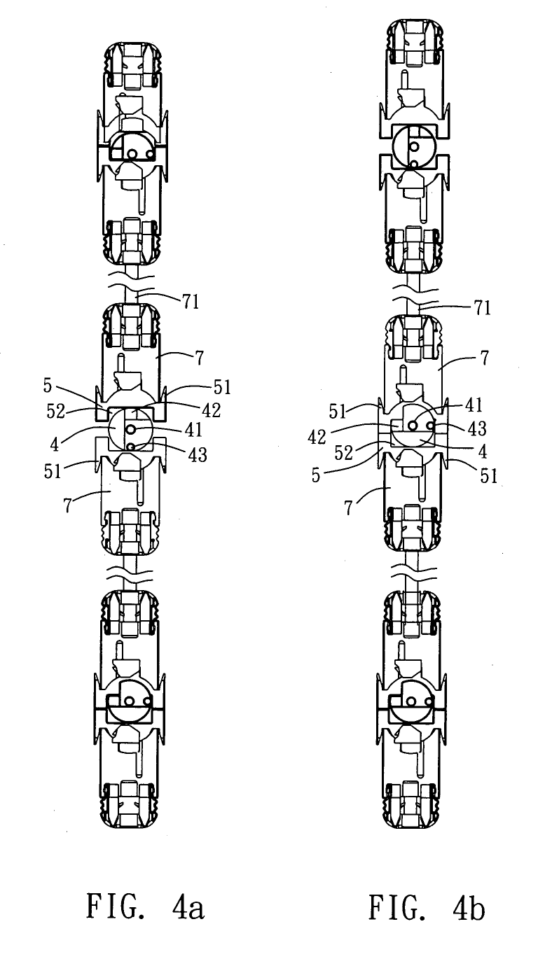

Referring to FIG. 4a, the interlock mechanism according to the present invention is installed in the middle drawer, such that the short side of the push rod 42 of the rotating part 4 in the notch 15 of the seat housing 1 is adjacently contacted with the joints 52 of the two followers 5. Also, the followers 5 are connected with the relay part 7 and the rotating part 4 of the upper and lower drawers by the relay part 7 and linking bar 71. Consequently, when the middle drawer is pulled out, the actuator 2 slides forwards into position along the inner slide rail 62 and the spline 24 drives the turn tenon 43 inside the limit groove 142. Consequently, the whole rotating part 4 rotates in the notch 15 on the back of the seat housing 1, and thus the long side of the push rod 42 is driven to push the joints 52 of the two followers 5, and thus the two sets of the relay part 7 and the linking bar 71 move upwards and downwards, respectively, to rotate the rotating plates of the slide rails of the upper and lower drawers, such that the joint of the follower abuts against the short side of the push rod of the rotating part to be engaged and latched (FIG. 4b) and to prevent the drawers from coming off.

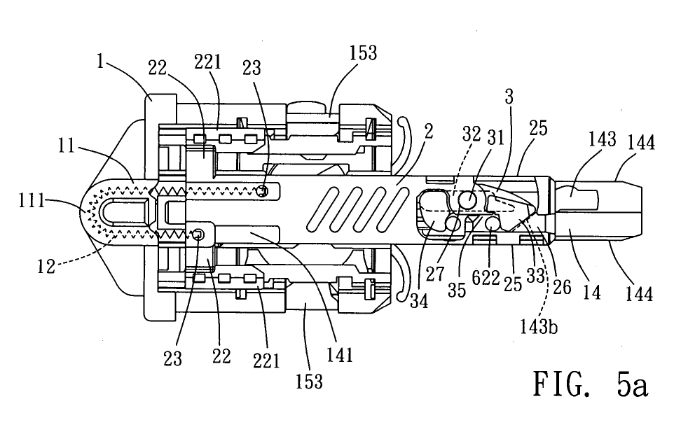

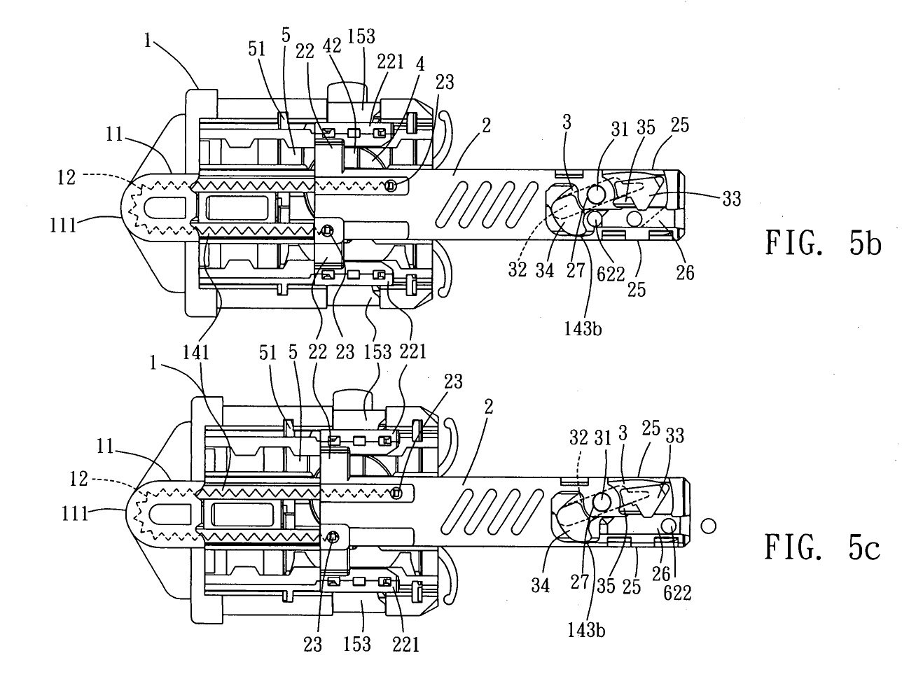

FIGS. 5a to 5c illustrate the normal operation procedure of the automatic retraction mechanism according to the present invention. When the drawer is being pulled out, the actuator 2 moves outwards along the seat housing 1 to stretch the spring 12 provided therebetween. At this moment, the swinging part 3 is located in the linear portion 143b and the two locking teeth 622 of the hook bolt 621 are engaged and latched with the hook groove 35 of the swinging part 3 (shown in FIG. 5a), driving the swinging part 3 and the actuator 2 outwards. When the two locking teeth 622 cross over the curved portion 143b and the swinging part 3 moves into the curved portion 143b, the guide rod 32 on the bottom of the swinging part 3 touches the outer edge of the curved portion 143b and thus stops moving forwards but drives the swinging part 3 to rotate. The rotating part 3 is then in close contact with and located at the inclined wall of the curved portion 143b and is thus in an inclined position. At this moment, when the drawer is being pulled further, the two locking teeth 622 of the hook bolt 621 will disengage from the swinging part 3, such that the drawer can be pulled outwards continuously.

On the other hand, when the drawer is being pushed in, the swinging part 3 is placed in the curved portion 143b and the back locking tooth 622 of the hook bolt 621 first crosses over the hook end 33 and then contacts the hook end 34 to disengage from latching, such that the swinging part 3 swings upwards to render the two locking teeth 622 closely engaged with the hook groove 225. At this moment, the spring 12 retracts and thus drives the hook bolt 621 and the actuator 2 to return to final position along the linear portion 143a, so as to achieve the expected function of automatic retraction.

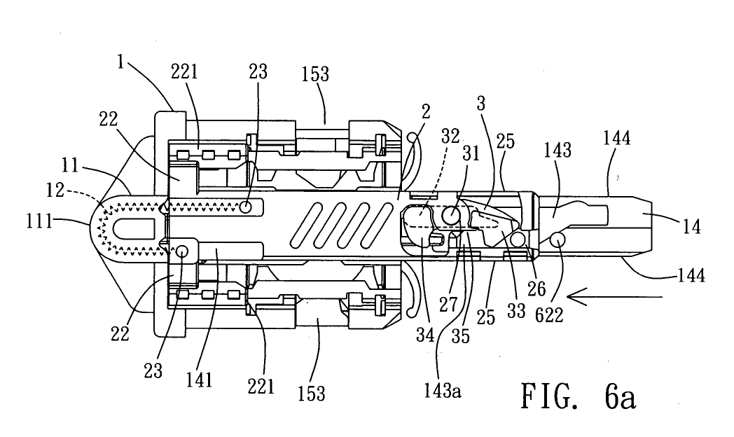

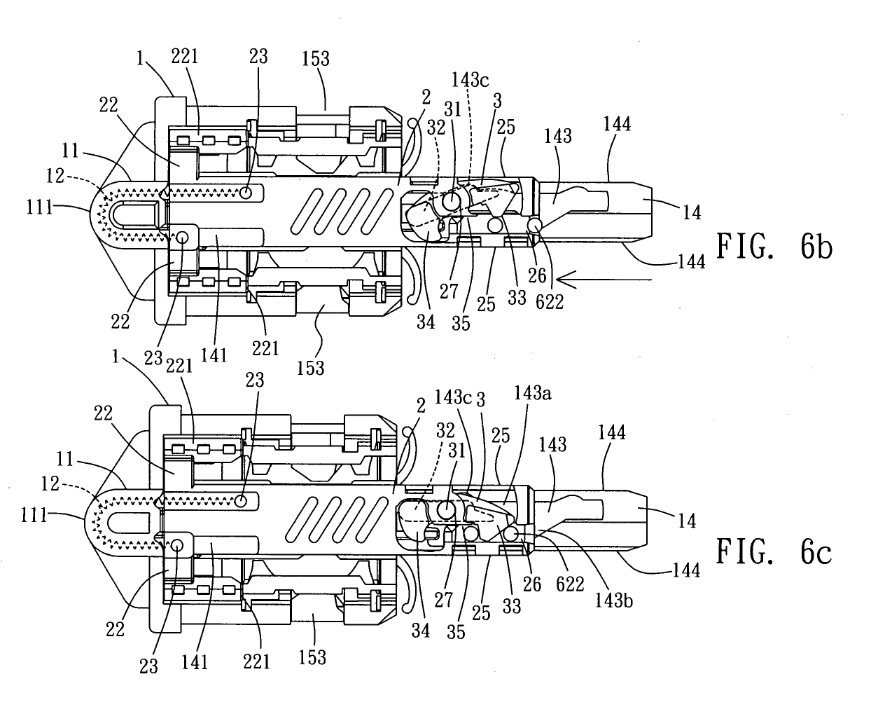

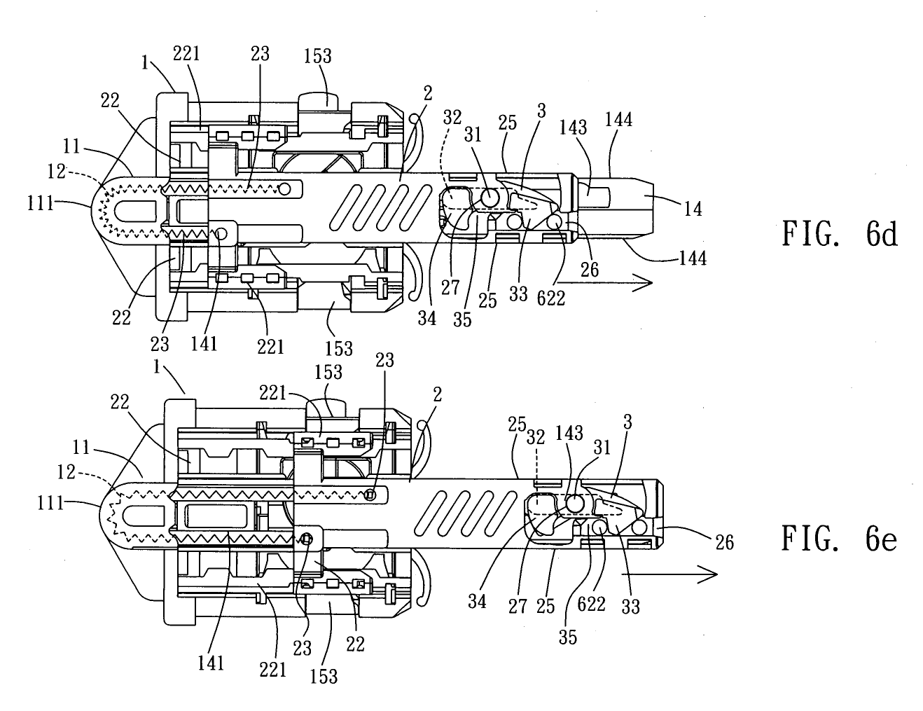

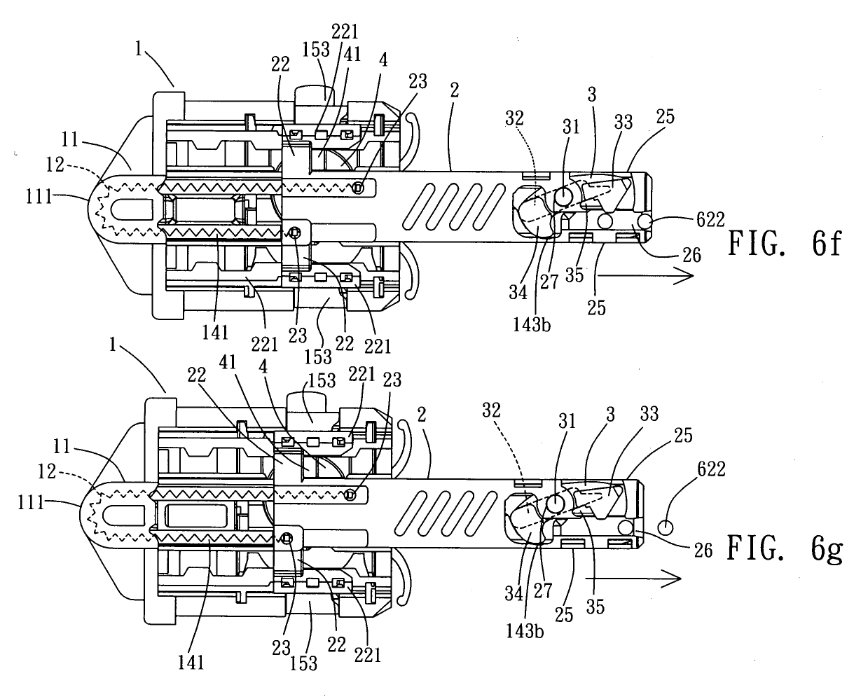

FIGS. 6a to 6g illustrate the abnormal operation procedure of the automatic retraction mechanism according to the present invention. The swinging part 3, for example, does not stay in the curved portion 143b to wait for the return of the inner slide rail 62, but instead stay in the linear portion 143a (shown in FIG. 6a). At this moment, the inner slide rail 62 and hook bolt 621 continuously push inwards until the inner locking tooth 622 abuts against the hook end 33, which subsequently moves upwards and in turn presses against the elastic segment (shown in FIG. 6b) formed by the fork groove 143c located in the linear portion 143a, and push further inwards to disengage the swinging part 3 from the fork groove 143c and back to the linear portion 143a. Then the locking teeth 622 are hooked by the hook end 33 (shown in FIG. 6c) to pull the inner slide rail 62 outwards and drive the swinging part 3 and the actuator 2 outwards (shown in FIG. 6d) until the guide rod 32 on the bottom of the swinging part 3 abuts against the outer edge of the curved portion 143b, so as to stop moving forwards (shown in FIG. 6e) and rotate the swinging part 3, which is then in close contact with and located at the inclined wall of the curved portion 143b and is thus in an inclined position (FIG. 6f). At this moment, when the drawer is being pulled out further, the inner locking tooth 622 of the hook bolt 621 disengages from latching the swinging part 3. The drawer is then able to be pulled out further (shown in FIG. 6g), so as to render the swinging part 3 to stay at the curved portion 143b and wait for the return of the inner slide rail 62 and the hook bolt 621, and thus eliminate the abnormal condition.

Accordingly, some important advantages of the present invention can be summarized as follows:
(1) The interlock mechanism is achieved by the transversal movement of the actuator to enable the spline on its bottom to drive the turn tenon protrudingly provided on the arc limit groove to rotate the swinging part axially connected with the bottom of the seat housing, such that the long side of the push rod pushes the two followers. The pushing mechanism changed linear motion to rotation is indeed different from the movement resulted from mutual push of two inclined planes.
(2) The guide groove of the linear portion and the curved portion according to the present invention can be basically regarded as a arrow-shape rail. Furthermore, the guide rod provided on the bottom of the swinging part is a long, slender rod, which possesses higher strength and will not fracture easily.
(3) When the actuator disengages from the hook bolt of the inner slide rail, the actuator does not move, but instead the swinging part is engaged and latched in the curved portion. Also, the springs are connected with the actuator in parallel and thus the connection does not affect the automatic retraction of the inner slide rail.
(4) The locking teeth of the hook bolt according to the present invention is specially designed with higher tolerance, 10˜20 mm for example, which can tolerates deviation resulted from the installation of the drawer slide rail.
(5) When the actuator and the hook bolt according to the present invention are in an abnormal condition, the inner locking tooth of the hook bolt is used to abut and push against the hook end of the swinging part and thus the hook stop on the other end springily falls, such that at least the back or front locking tooth or both engage with the spline to eliminate the abnormal condition.

While the invention has been described with reference to the a preferred embodiment thereof, it is to be understood that modifications or variations may be easily made without departing from the spirit of this invention, which is defined by the appended claims.

What is claimed is:

1. An interlock mechanism for drawer slide rail, installed in at least two vertically arranged drawers, each of which outer wall and an object's inner wall are provided with a drawer slide rail, respectively, formed by an inner and outer slide rails, comprising:
a seat housing connectingly provided in the end of an outer slide rail, wherein the center of the seat housing extends outwardly to form a belt-like protrusion which is provided with a arc limit groove in its middle;
an actuator comprising a cover plate slidingly connected in front of the seat housing and a twisted spline provided on the inner side of the cover plate corresponding to the limit groove;
a rotating part axially connected to the back of the seat housing, wherein the inner side of the rotating part axially extends to form a push rod whose one end is protrudingly provided with a turn tenon which passes through the limit groove and is fittingly connected with the spline;
at least a follower slidingly provided on the back of the seat housing and adjacently connected to the recessed joint provided on the rotating part; and
a hook bolt connectingly provided at the end of a slide rail; when the actuator moves into position along the inner slide rail, a spline will drive a turning tenon of the rotating part to protrude over the limit groove of the seat housing, and thus the motion of the turning tenon changes from linear movement to rotating movement so as to turn the rotating part into rotating movement, and in turn drive the push rod's long side to push the joint of the follower to move longitudinally.

2. The interlock mechanism for drawer slide rail as defined in claim 1, further comprising an automatic retracting mechanism which comprises:
a seat housing connectingly provided in the end of an outer slide rail, wherein the center of the seat housing extends outwardly to form a protrusion whose front portion is cut to form a guide groove formed by a linear portion and a curved portion interlinked with the front of the linear portion;
an actuator comprising a cover plate slidingly connected in front of the seat housing and a spring connectingly provided between the actuator and the cover plate whose front end is formed a groove and an axial hole;
a swinging part whose top is protrudingly provided with an axial rod for the pivotal connection of the axial hole, whose bottom protrudes to form a belt-like guide rod fittingly connected to the guide groove, and whose respective sides on its top are provided with a hook end and a hook stop, respectively, between which a hook groove is formed; and
a hook bolt connectingly provided at the end of the inner slide rail and protrudingly provided with two detached locking teeth corresponding to the groove; with the inner slide rail being pulled out, the spring extends and in turn the guide rod touches the outer edge of the curved portion to turn the swinging part, which is in close contact with and located at the inclined wall of the curved portion. The swinging part therefore moves to an inclined position to render the hook bolt to disengage from the latching of the swinging part. With the inner slide rail being pushed back, the locking teeth of the hook bolt contact hook groove's inner wall of the swinging part provided at the curved portion and are accommodated inside the hook groove so as to disengage from latching and in turn to retract the spring to drive the actuator and the hook bolt retract along linear portion automatically.

3. The interlock mechanism for drawer slide rail as defined in claim 2, wherein behind the seat housing is provided with a curved portion for the fitting connection of a spring, on the back of the actuator is protrudingly provided with two spring tenons which are connected with both sides of the spring, respectively.

4. The interlock mechanism for drawer slide rail as defined in claim 1, wherein the upper and lower sides of the seat housing are provided with a pair of parallel wing grooves and the upper and lower sides of the actuator's cover plate extend to form a wing plates, respectively, whose edges are provided with hook grooves bending downwards to fasten with the wing grooves, such that the actuator can move transversely on the surface of the seat housing; also, the upper and lower of the front end of the cover plate bend, respectively, downwards to form fastening wings so as to fasten with the upper and lower edges of the protruding portion.

5. The interlock mechanism for drawer slide rail as defined in claim 1, wherein a relay rail is provided between the outer slide rail and the inner slide rail.

6. The interlock mechanism for drawer slide rail as defined in claim 1, wherein the inner of the notch on the back of the seat housing is adjacently connected with the an axial tenon protrudingly formed from one side of the limit groove such that the tenon hole on the center of the rotating part can be pivoted rotatably therein.

7. The interlock mechanism for drawer slide rail as defined in claim 6, wherein the left and right sides of the notch opposingly form a pair of plate grooves, such that the two plate edges of the two ends of the actuator can move longitudinally on the plate groove.

8. The interlock mechanism for drawer slide rail as defined in claim 6, wherein the intersections of the notch and the wing grooves form a stop rod, respectively, to act the limits of the movement of the stop plate protrudingly formed from the front of the actuator.

9. The interlock mechanism for drawer slide rail as defined in claim 1, wherein the follower is further connected with a relay part extendingly provided with a linking bar.

10. The interlock mechanism for drawer slide rail as defined in claim 1, wherein an elastic segment formed by a fork groove of the linear portion of the guide groove, and when the hook bolt moves inwards until the inner locking tooth contacts and pushes against the hook end, which in turn presses against the elastic segment, such that the back or front locking tooth or both engage with the spline.
